(19) United States
(12) Patent Application Publication
(10) Pub. No.: US 2002/0053461 A1
(43) Pub. Date: May 9, 2002

(54) CONDUCTOR FOR HIGH-VOLTAGE WINDINGS, AND A PROCESS FOR PREPARING SUCH CONDUCTOR

(76) Inventors: MATS LEIJON, VASTERAS (SE); KENNETH JOHANNESSON, LYCKEBY (SE); STEFAN MILTON, RAMDALA (SE); PETER CARSTENSEN, HUDDINGE (SE); BENGT RYDHOLM, VASTERAS (SE); BO HERNNAS, VASTERAS (SE); VIJAYA CHANDRAMOULI, VASTERAS (SE)

Correspondence Address: OBLON SPIVAK MCCLELLAND, MAIER & NEUSTADT, 1755 JEFFERSON DAVIS HIGHWAY, FOURTH FLOOR, ARLINGTON, VA, 22202

(21) Appl. No.: 09/147,323

(22) PCT Filed: May 28, 1997
(86) PCT No.: PCT/SE97/00877

(51) Int. Cl. H01B 5/08

(52) U.S. Cl. 174/128.1

(57) ABSTRACT

A conductor for high-voltage windings comprising a stranded conductor core surrounded an electrical high-voltage insulation comprising an inner semi-conducting layer, an insulating layer and an outer semi-conducting layer. The core being designed to ensure uniform current distribution and to counteract eddy-current losses This is achieved by an electrically insulating oxide layer being provided on a sufficient number of strands to ensure that all strands in the stranded conductor core are electrically insulated from each other.

### TECHNICAL FIELD

The present invention relates to a conductor for a high-voltage winding in an electric or electromagnetic device for electric power purposes to be used in any electrotechnical connection. The invention relates in particular to conductors for high-voltage windings which comprises a plurality of strands. High voltages are primarily intended, up to the highest transmission voltages used.

The invention relates in particular to a conductor intended for a high-voltage winding in rotating electrical machines, e.g. a synchronous machines, but also to dual-fed machines, applications in asynchronous static current changer cascades, outerpole machines and synchronous flow machines as well as to alternating current machines intended primarily as generators in a power station for generating electric power.

But the invention is also applicable for a conductor intended to be used in a high-voltage winding of a power transformer or reactor.

The invention also relates to an electrical machine with a high-voltage winding comprising a conductor according to the present invention.

This invention also relates to a process for preparing a conductor according to the present invention suitable to be used in a high-voltage winding of an electrical device.

### BACKGROUND ART

Although the following description of the prior art mainly refers to high-voltage windings of rotating electrical machines and in particular to the stator winding of a generator, the present invention is also applicable to other high-voltage windings, such as high-voltage windings in transformers and reactors. Transformers and reactors are used to allow exchange of electric energy between two or more electric systems for transmission and distribution of electrical power and the electric windings are used for electromagnetic induction in a well-known manner. The transformers and reactors primarily intended with the present invention have a rated power of from a few hundred kVA up to more than 1000 MVA with a rated voltage of from a few kV up to the highest transmission voltages, 400 to 800 kV or higher.

A winding in known generators consists of a number of insulated rectangular copper wires. In the case of a stator winding these strands are transposed (i.e. change place with each other) and are surrounded by a common insulation in such a way that the bundle of conductors acquires a rectangular cross section. The copper conductors are rectangular in order to reduce the eddy-current losses, the linear dimension in the direction of the magnetic field shall be small.

A conductor according to the present invention for a high voltage winding comprises a plurality of strands of an electrically conductive metal such as copper, aluminum or other suitable metal or alloy usually having circular cross section and being of thin gauge i.e. having a diameter below 4 mm. The strands are arranged as a conductor core surrounded by a high-voltage insulation comprising a first semi-conducting layer, an insulating layer and a second semi-conducting layer. Thus the concept for an insulated conductor as used according to this invention does not include the outer protective sheath that surrounds an insulated high-voltage cable when used for transmission or distribution of electrical power. Furthermore, in a high-voltage cable for power distribution there is also an outer insulating layer on top of the second semi-conducting layer. A rotating electrical machine comprising a winding with such insulated conductor is described in more detail in co-pending Swedish patent application No. SE-9602079-7.

However, a conductor with rectangular cross section in a high-voltage insulation, i.e. in a conductor, provides much greater field strength at the corners of the conductor, the corners thus being dimensioned for the thickness of the insulation. Optimal insulation thickness is achieved with circular conductors.

Circular conductors can be constructed in a great number of different ways. The conductor may, for instance, consist of:

1) a solid rod of copper or other metal with circular cross section,

2) a conductor stranded from circular wires having the same or different diameters,

3) a conductor stranded from sectioned wires,

4) a conductor compressed from a number of segments, each of which is in turn stranded from circular wires and then formed to a segment.

To ensure high power transmission in voltage-transmission lines with a conductor for a given voltage, the current strength must be increased, which is only possible if the conductor area is increased. As the current strength increases the current distribution in the conductor is affected and becomes uneven, the current endeavors to reach the outer surface of the conductor, and what is known as a “skin effect”, current pinch effect, is obtained. To counteract this, conductors having large cross section, >1200 mm² Cu, are produced, usually called Millikan conductors, i.e. conductors built up of a number of concentrically arranged wires which have subsequently been compressed and shaped. Such a conductor is often composed of 5 or 7 segments which are in turn insulated from each other. Such a construction is effective in reducing current pinch effect in transmission and distribution cables for high voltage.

In distribution systems for high-voltage power transmission all the strands in the cable have been insulated with varnish, for instance, in order to reduce the current pinch effect, see the publication Hitachi Cable Review, No. 11, August 1992, pages 3-6: “An EHV Bulk Power Transmission Line Made with Low Loss XLPE Cable”. No application of this technology on generator windings is described.

With generators having conventionally designed windings as described above, the upper limit for generated voltage has been deemed to be 30 kV. This usually means that a generator must be connected to the power supply system via a transformer which steps up the voltage to the level of the power supply system,—in the range of 130-400 kV or higher.

By using conductors of substantially the same type as in High-Voltage cables for transmission and distribution of electric power in the windings of the generator, in accordance with the invention, the voltage of the machine is increased to such a level that it can be connected directly to the power supply system without intermediate transformers.

The concept when applied to a stator winding generally requires the slots in which the insulated conductors are placed in the stator to be deeper than with conventional technology, thicker insulation due to higher voltage and more turns in the winding. This entails new problems with regard to mechanical natural oscillation in the stator teeth (the spaces between the stator slots) and cooling thereof.

Fitting the insulated conductor in the slot is also a problem—the conductor must be inserted into the slot without its outer layer being damaged. The conductor is subjected to currents having a frequency of 100 Hz which cause a tendency to vibration and, besides manufacturing tolerances with regard to the outer diameter, its dimensions will also vary with variations in temperature, i.e. load variations.

The conductor is provided with an outer semi-conducting layer with the aid of which its potential in relation to the surroundings shall be defined. This layer must therefore be connected to earth, at least somewhere in the machine, possibly only in the coil-end section. This earth connection can presumably be subjected to considerable stress in the event of faults in the power supply system.

In order to serve its purpose as earth connection, the outer semi-conducting layer should have low resistance. On the other hand heat losses will then occur due to magnetically induced currents, which means that its coherent length must perhaps be limited.

The electric conductor according to the invention comprises a plurality of twisted layers consisting of wires, also known as strands, of an electrically conductive metal such as copper, aluminum or other suitable metal or alloy usually having circular cross section and being of thin gauge i.e. having a diameter below 4 mm. However, contrary to conventional conductors in cables for power transmission, the electrically conducting layer of the conductor is subjected to a magnetic field which induces currents, resulting in losses. In order to reduce these losses, therefore, the strands must be electrically insulated from each other. It is known to use insulated strands with such as enameled wire, wires with a layer of polymeric material in the form of varnish, e.g. epoxy, wax etc., thermo-plastic materials such as polyeten and oxide layers. The organic material have however a low capability to withstand severe conditions such as high temperatures and must normally be applied in relatively thick layers, at least too thick to be used as insulation on strands comprised in a conductor according to the present invention. Furthermore the use of organic materials might complicate recycling of conductor material. The use of inorganic insulating materials based on glass fibre or mica for applications where resistance to high temperatures, vacuum, fire or chemical attacks is required is known however this produces thick layers.

### DESCRIPTION OF THE INVENTION

The present invention is intended for use at high voltages, which here refers primarily to voltages in excess of 10 kV. A typical operating range for a device according to the invention may be voltages from 36 kV up to 800 kV.

The object of the present invention is thus in electrical machines for voltages up to 500 kV or more, to ensure uniform current distribution and counteract eddy-current losses by insulating the strands in a stranded conductor comprised in a high-voltage winding electrically from each other. Such electrical insulation on the strands must be sufficiently ductile and mechanically stable, and have a sufficient wear strength to avoid being damaged during application. Such insulation must also exhibit sufficient electric resistivity and electric strength to counteract the eddy-current losses. Further this insulation must when provided in the form of thin insulation layer on a strand exhibit a sufficient adherence to the surface of the strand not to spall during conductor manufacturing, winding application or thermal cycling in use of electrical machine.

A further object of some embodiments of the invention is to ensure that the inner semi-conducting layer of the insulation system has the same potential during operation as the strands in the conductor.

A further object of this invention is to provide a process to prepare a conductor according to the invention including the step to generate a suitable electrical insulation on one or more strands to be used to electrically insulate all strands relative each other in a stranded and insulated conductor according to the present invention.

The main object is achieved by making a conductor for high-voltage windings in an electric device, which comprises conductor core, exhibiting a plurality of strands in an electrically conductive metal or alloy, and a solid electrical high voltage insulation surrounding said stranded conductor core, where said electrical insulation comprises an inner semi-conducting layer, an electrically insulation layer and an outer insulating layer, and the metal strands are electrically insulated from each other by an electrically insulating layer comprising an oxide of a metal comprised in the strand, e.g. CuO for a copper based strand or Al₂O₃ for aluminum based strand, provided on a sufficient number of strands to ensure that all strands are electrically insulated from each other. The strands in the conductor core is preferably in the form of thin gauge copper or aluminum wire, i.e. with a diameter below 4 mm. Minimization of the eddy current losses is achieved by ensuring that the strands used in the finished conductor according to the invention do not have a diameter exceeding 4 mm, preferably a diameter less than 2 mm.

The oxide-comprising, electrically insulating layer exhibits, to fulfill the dimensional, mechanical and electrical objectives a thickness below 10 μm, preferably a thickness of 1 to 5 μm.

When formed on a wire comprising copper this insulation layer exhibits a transition zone which comprises indentations in the copper surface filled with copper oxide between the metal and oxide layer. This transition zone improves the adherence of the oxide layer to the metal strand but it also improves the electric insulation between to adjacent strand by reducing the effective contact surface substantially and thus increasing the contact resistance between to adjacent strands due to a current pinch effect. This side effect can not be neglected as the object of the insulation of the strand is to withstand relatively small voltages, essentially voltages below 10 volts. However the main electrical insulation is provided by the copper oxide-layer which due to its suitable electrical, mechanical and physical properties provide the required resistance, strength and adherence required of an insulation in this application.

The insulating copper oxide-layer is preferably generated on the strand by forced oxidation in an aqueous solution or bath. The oxidation is mild and e.g. achieve by electrolytic oxidation, anodization, using a low current density below 1000 A/m², preferably a current density of 300-700 A/m², or a chemical oxidation using a water soluble oxidant such as a chlorite, a persulfate or a nitrate.

The surface of a raw untreated thin gauge copper or copper based strand exhibits small indentations. This indentations, which normally have a depth of 1 μm and are located at distance of approximately 20 μm from each other, most likely originates from the die in the wire-drawing process. During oxidation under conditions as specified these indentations are enlarged and the metallic copper is converted to copper oxide which fills the indentations. This structure develops in the oxide layer which comprises a transition zone adjacent to the metal. The indentations or pits show after oxidation a size of approximately 5 μm and the distance between them have been reduced to 5-10 μm. Outside the transition zone the oxide layer tends to generate an even outside surface resembling the topography of the original copper surface, i.e. the indentations are not as pronounced as in the interface metal/oxide in the transition zone. Anodization and chemical oxidation as described in the foregoing do create a oxide layer with similar structure save for that the indentations are more rounded and even after the chemical process while they are more irregularly shaped after anodization. But as already described these pits are not reflected in the outer surface of the oxide layer which has a topography similar to the original copper wire. As to the structure within the oxide layer it is essentially solid with small cracks and some porosity. There appears to be a tendency for the chemically formed oxide layer to be more porous.

A suitable oxide layer comprising copper oxide can be achieved by both chemical oxidation and electrolytic treatment as will be exemplified.

On an aluminum strand the Al₂O₃-comprising layer exhibits to fulfill the dimensional, mechanical and electrical objectives a thickness below 10 μm, preferably a thickness of 1 to 5 μm. This insulation layer also exhibits a transition zone which comprises a barrier oxide layer closest to the aluminum metal and a porous oxide layer on top of this. Normally a so called sealing procedure is performed where the oxide layer is boiled in clean water.

This procedure creates aluminium hydrate that will seal the pores, making the surface smooth and nonporous. The aluminium oxide layer shows a significant bonding strength to the aluminum surface, inhibiting any kind of delamination between the oxide and metal. Since the oxide comprises a high resistivity it will improve the electric insulation between to adjacent strands. If a small thickness of the oxide layer is chosen it will still withstand relatively high voltages, essentially voltages below 10 volts. A rule of thumb that most often is used for anodized aluminum layers is the electrical strength of 25 V per micron. The main electrical insulation that is provided by the Al₂O₃-layer which due to its suitable electrical, mechanical and physical properties provide the required resistance, strength and adherence required of an insulation in this application.

The insulating Al₂O₃ layer is preferably generated on the strand by forced oxidation in an aqueous solution or bath. The oxidation is mild and e.g. achieve by electrolytic oxidation, anodization, using a low current density below 1000 A/m², preferably a current density of 100-250 A/m². The electrolyte solution most commonly comprises sulphuric acid, but chromic acid and oxalic acids may also be used.

To generate a suitable oxide layer on a thin gauge copper wire, e.g. a 2-4 mm copper wire by chemical oxidation a bath containing an alkaline aqueous solution comprising a water-soluble oxidant is prepared by addition of;

5-40 parts by weight of sodium hydroxide;

5-40 parts by weight of sodium chlorite; to

100 parts by weight of water.

The solution in the bath is heated to a temperature of 50 to 120° C. and maintaining the solution at approximately this temperature while submerging a thin gauge, 3 mm, copper wire into the bath and keeping it submerged for a period of time of 10 seconds to 15 minutes. This chemical oxidation will generate a oxide layer with a thickness of 1-5 μm on the copper strand.

The oxide layer will exhibit the transition zone as described in the foregoing and some porosity which according to an embodiment can be at least partly filled by including a binder such as an acrylate or benzotriazole in the bath solution at a rate of 0.1 to 20 parts by weight, such addition will not alter the treatment process or the resultant oxide layer but for the filling of pores. Strands with an oxide layer generated according to the process described in this paragraph have shown most suitable for inclusion in a insulated conductor according to the invention for a winding in a high-voltage rotating electrical machine to achieve the improvements relative more uniform current distribution in the conductor and reduction of eddy-current losses desired.

A anodizing process suitable to generate the desired oxide layer on a thin gauge copper wire, e.g. a 2-4 mm copper wire will be performed using a highly alkaline aqueous electrolyte, a current density below 1000 A/m², preferably a current density in the range 300-700 A/m², a chemical oxidation potential in the electrolyte corresponding to that for the conversion Cu+Cu₂O/CuO. A treatment time of upto 5 minutes. The fully oxidation of the copper surface will be indicated by gas evolution. Suitable cathode material is stainless steel. Also strands with an oxide layer generated according to the anodizing process described in this paragraph have shown most suitable for inclusion in a insulated conductor according to the invention for a winding in a high-voltage rotating electrical machine to achieve the improvements relative more uniform current distribution in the conductor and reduction of eddy-current losses desired.

Insulation layers generated along the principle described in the fore-going provides sufficient electrical insulation by the CuO-layer which due to its suitable electrical, mechanical and physical properties provide the required resistance, strength and adherence required of an insulation. The transition zone with its indentations filled with copper oxide improves the adherence of the oxide layer to the copper strand but it also results in an electric side effect by reducing the effective contact surface substantially and thus increasing the contact resistance between two adjacent strands due to a current pinch effect. This side effect can not be neglected as the object of the insulation of the strand is to withstand relatively small voltages, essentially voltages below 10 volts.

The above-mentioned object of the present invention is optimized by the various embodiments as expressed in the sub-claims.

According to one further embodiment it is ensured that the inner semi-conducting layer of the insulation system has the same potential during operation as the strands in the conductor by arranging the electrical insulation of the strands such that only certain strands are provided with an electrically insulating oxide layer and situating the strands such that no two unoxidized, i.e. uninsulated strands come into electrical contact with each other while ensuring that at least one insulated strand is in electrical contact with the inner semi-conducting layer of the high-voltage insulation surrounding the stranded conductor. This can be materialized using several different constructions of the stranded conductor which will be exemplified in the following. An example of a conductor according to this embodiment exhibits circular insulated and uninsulated strands having uniform cross section. The strand are arranged in layers which exhibit alternating stranding direction and the following numbers of strands in the different layers starting from the center, 1+6+12+18. The insulated strands are present in all layers of the conductor, while the electrically uninsulated strand alternate strands with insulated strands in the second and fourth layer. This will result in that the nine uninsulated strands in the outer layer, the fourth layer, will be in electrical contact with the inner semi-conducting layer of the high-voltage insulating surrounding the stranded conductor core. In alternate embodiments alternative stranding directions and insulating shields between layers are employed to ensure that no two uninsulated strands will be in contact with each other. The conductor according to this embodiment of the invention may of course be made up of more or fewer strand layers depending on the demands placed on the conductor in the stator winding of the generator. It is also possible to make the strand layers out of pre-shaped strands, in which case the cross section of the conductors can be minimized. In other variations the conductor according to the invention may have strands with different cross section in the various layers but a condition for the potential on the conducting strand layers being the same as on the inner semi-conducting layer of the conductor during operations is that the outer layer of strands has at least one uninsulated strand which is thus in electrical contact with the semi-conducting layer. In order to achieve a uniform cross section between the insulated strands and the uninsulated strands the electrically conducting area of the insulated strands may be less than the area of the uninsulated strands. The arrangement with alternating uninsulated and insulated strands in the conductor core is described in more detail in the co-pending Swedish patent application SE-9602093-8.

When preparing a conductor according to the present invention on or more of the strands are first provided with an electrically insulating oxide layer as described in the foregoing.

Then the wires are stranded to a conductor core with an arrangement of the strands as described in the forgoing to ensure that all strands are electrically insulated relative each other or comprising only oxidized strands. The stranded conductor core are then provided with the solid insulating system, e.g. by co-extrusion of the three layers. In an embodiment all three layers comprise polyethylene, which suitably is cross linked, i.e. what is normally called XLPE, cross-linked polyethylene. Other suitable materials are other thermoplastic materials and rubbers compounds such as EPDM and EPM. The two semi-conductive layers normally comprise an addition of a particulate filler of electrically conducting or semi-conducting material such as carbon, in the form of soot, carbon black or other graphite based material, a metal powder or a semi-conductive inorganic filler but can also comprise a polymeric material with intrinsic electrical conductivity.

Preferred embodiments

The process for preparing a conductor for a winding in a high-voltage electric device according to the present invention will be illustrated further in the following description of a number of embodiments by way of examples for several processes for the forced oxidation to generate the metal-oxide layer on strands to be employed.

### EXAMPLE 1

A bath containing an alkaline aqueous solution comprising a water-soluble oxidant was prepared by addition of;

20 parts by weight of sodium hydroxide;

25 parts by weight of sodium chlorite; and

10 parts by weight of a dispersed acrylate to

100 parts by weight of water.

Heating the solution in the bath to 80° C. and maintaining the solution at approximately this temperature while submerging a thin gauge, 3 mm, copper wire into the bath and keeping it submerged for 10 minutes. This chemical oxidation generated a 1 μm thick oxide layer on the copper strand, and the inclusion of such strands in a insulated conductor according to the invention for a winding in a high-voltage rotating electrical machine has proven to give the improvements relative more uniform current distribution in the conductor and reduction of eddy-current losses.

### EXAMPLE 2

The process according to example 1 was repeated save for that the acrylate was replaced by benzotriazole. Also this treatment resulted in a 1 μm thick oxide layer which exhibited the same performance when included as a strand in an insulated stranded conductor for a high-voltage winding according to the invention.

### EXAMPLE 3

A bath containing an alkaline aqueous solution comprising a water-soluble oxidant was prepared by addition of;

30 parts by weight of potassium hydroxide;

25 parts by weight of potassium chlorite; and

10 parts by weight of a dispersed acrylate to

100 parts by weight of water.

Heating the solution in the bath to 100° C. and maintaining the solution at approximately this temperature while submerging a thin gauge, 3 mm, copper wire into the bath and keeping it submerged for 10 minutes. This chemical oxidation generated a 3 μm thick oxide layer on the copper strand, and the inclusion of such strands in a insulated conductor according to the invention for a winding in a high-voltage rotating electrical machine has proven to give the improvements relative more uniform current distribution in the conductor and reduction of eddy-current losses.

### EXAMPLE 4

The process according to example 3 was repeated save for that the acrylate was replaced by benzotriazole. Also this treatment resulted in a 3 μm thick oxide layer which exhibited the same performance when included as a strand in an insulated stranded conductor for a high-voltage winding according to the invention

### EXAMPLE 5

A bath containing an alkaline aqueous electrolyte was prepared by addition of 40 parts by weight of sodium hydroxide to 100 parts by weight of water.

Heating the electrolyte in the bath to 100° C. and maintaining the solution at approximately this temperature while anodizing a thin gauge, 3 mm, copper wire using a current density of 450-600 A/m². A voltage of −0.22 V was measured between the anode and a Ag/AgCl reference electrode, which corresponds to the chemical potential for the Cu+Cu₂O/CuO conversion. When the copper surface was fully covered with copper oxide this potential increased and gas was generated at the anode, which occurred after 60 to 180 seconds. The process was then stopped. The resulting oxide layer had a thickness of 2-6 μm and comprised a mixture of the two copper oxides Cu₂O and CuO. Also the inclusion of such strands in an insulated conductor according to the invention for a winding in a high-voltage rotating electrical machine has proven to give the improvements relative more uniform current distribution in the conductor and reduction of eddy-current losses.

### EXAMPLE 6

A bath containing an sulphuric acid aqueous electrolyte was prepared by addition of 20 parts by weight of sodium hydroxide to 100 parts by weight of water.

Keeping the electrolyte in the bath to 20° C. and maintaining the solution at approximately this temperature while anodizing a thin gauge, 3 mm, aluminum wire using a current density of 150-200 A/m², at a voltage of 18 V. The process time was about 10 minutes. The oxide layer thickness obtained was about 3-6 μm.

Also the inclusion of such strands in an insulated conductor according to the invention for a winding in a high-voltage rotating electrical machine has proven to give the improvements relative more uniform current distribution in the conductor and reduction of eddy-current losses.

### EXAMPLE 7

The procedure in example 6 was repeated and an additional step was added. The anodized wire was boiled in pure water for approximately 30 min in order to obtain a sealing of the pourous oxide. Due to the small thickness of the layer the ductility of the strand was not critically influenced by the sealing process.

Also the inclusion of such strands in an insulated conductor according to the invention for a winding in a high-voltage rotating electrical machine has proven to give the improvements relative more uniform current distribution in the conductor and reduction of eddy-current losses.

Although the conductor incorporating the insulated strands have been tested only in high-voltage windings of rotating electrical machines it is obvious for the skilled man that such conductors can also be used for high-voltage windings in other type of electrical devices such as transformers or reactors.

1. A conductor for high-voltage windings in an electrical device comprising a conductor core, exhibiting a plurality of metallic electrically conductive strands, characterized by an electrical high voltage solid insulation arranged to surround said stranded conductor core, where said electrical insulation comprises an inner semi-conducting layer, an electrically insulation layer and an outer insulating layer, and that the metallic strands in said conductor core are electrically insulated from each other by an electrically insulation, comprising an oxide of a metal comprised in the strands, and that the electrical insulation is provided on a sufficient number of strands to ensure that all strands are electrically insulated from each other.

2. A conductor as claimed in claim 1, characterized in that the strands have a diameter less than 4 mm.

3. A conductor as claimed in claim 2, characterized in that the strands have a diameter less than 2 mm.

4. A conductor according to any of claims 1 to 3, characterized in that the electrically insulating oxide layer have a thickness less than 10 μm.

5. A conductor according to claim 4, characterized in that the electrically insulating oxide layer have a thickness of 1 to 5 μm.

6. A conductor according to any of claims 1 to 5, characterized in that the electrically insulating oxide layer exhibits a transition zone located between the surface of the metallic strand and the outer surface of the oxide layer and that said transition zone comprises indentations in the metallic surface filled with oxide.

7. A conductor according to any of claims 1 to 6, characterized in that the electrically insulating oxide layer exhibits a porosity.

8. A conductor according to claim 7, characterized in that the pores in electrically insulating oxide layer is at least partly filled with an organic polymeric material.

9. A conductor according to any of claims 1 to 8, characterized in that the metal strand comprises an electrically insulating oxide layer comprising metal oxide formed on its surface by forced oxidation of the strand in an aqueous solution.

10. A conductor according to any of claims 1 to 9 characterized in that the conductor strand is made of copper and that the electrically isulating oxide comprises CuO.

11. A conductor according to any of claims 1 to 9 characterized in that the conductor strand is made of aluminum and that the electrically isulating oxide comprises Al₂O₃.

12. A conductor according to any of claims 1 to 3, characterized in that the strands are arranged in concentric layers with alternating stranding direction in to adjacent layers, at least one strand being uninsulated in the outermost layer and that said uninsulated strand is in electric contact with the inner semi-conducting layer of the conductor insulation.

13. An electric device with a high voltage winding comprising a conductor as claimed in any of the preceding claims.

14. A process for preparing a conductor, comprising a conductor core exhibiting a plurality of electrically conducting metallic strands, for a high-voltage winding according to any of the preceding claims, characterized in that an electrically insulating oxide layer comprising a metal oxide is generated on the surface of a strand to be used in the stranded conductor, by forced oxidation of the metallic strand in an aqueous solution, then the strands are stranded to form said core and arranged in such a way that all strands in said core are electrically insulated from each other by the electrical insulation provided on a sufficient number of strands to ensure that all strands are electrically insulated from each other and that a solid insulation comprising, a first inner semi-conducting layer, an electrically insulation layer and a second outer semi-conducting layer, is applied around the stranded conductor core.

15. A process according to claim 14, characterized in that the strand wire comprises copper and is oxidized in an alkaline aqueous solution.

16. A process according to claim 14, characterized in that the strand wire comprises aluminum and is oxidised in an acidic aqueous solution.

17. A process according to claim 15, characterized in that the copper-containing wire is oxidized in the presence of a water-soluble oxidant.

18. A process according to claim 17, characterized in that the oxidant is a chlorite, a persulphate or a nitrate.

19. A process according to claim 15 or 16, characterized in that the wire is anodized in an electrolyte using a current density of less than 1000 A/m².

20. A process according to claim 19, characterized in that the wire is anodized in an electrolyte using a current density in the range 100 to 700 A/m².

21. A process according to claim 19 or 20, characterized in that the chemical potential in the electrolyte essentially corresponds to the chemical potential of the conversion metal/metal-oxide to the wire metal's most oxidised state.

22. A process according to any of claims 14 to 21, characterized in that the oxidation is carried out at a temperature of 20 to 120° C.
